(19) United States
(12) Patent Application Publication
(10) Pub. No.: US 2025/0002297 A1
(43) Pub. Date: Jan. 2, 2025

(54) SYSTEM AND METHOD FOR THE CONSTRUCTION OF A MULTI-PLANAR LIGHTWEIGHT INTEGRATED POST AND HANDRAIL ASSEMBLY

(71) Applicant: AMPP, Incorporated, Perrysburg, OH (US)

(72) Inventors: Joseph L. Young, Toledo, OH (US); James E. Roberts, Toledo, OH (US)

(21) Appl. No.: 18/758,068

(22) Filed: Jun. 28, 2024

Related U.S. Application Data
(60) Provisional application No. 63/524,376, filed on Jun. 30, 2023.

(51) Int. Cl. B66B 5/00

(52) U.S. Cl. CPC B66B 5/0081

(57) ABSTRACT

An integrated telescopic rail and modular post assembly includes a first elongate post comprising an assembly of a first and second component that together define a square in cross section, with not less than seven (7) bends along the length of the elongate post, a handrail having a first end affixed to the first elongate post, the handrail including an elongate, inner handrail member of not less than five (5) bends along its length, received within an elongate, outer handrail member of not less than six (6) bends along its length, and a mechanical bracket mimicking and enveloping the surface profiles of the elongate posts and handrails comprised of apertures which envelope about the profiles of the elongate rail and post members, the integration of which resists outward or inward applied longitudinal or lateral forces.

### FIELD OF THE INVENTION

The invention relates to safety handrail environments requiring compliance with ASME A17.1-2016 and Ontario Regulation 209/01 CAD 277-19 more particularly, to a structural system and method for the lightweight construction of an equivalent to welded tube mechanical top of car handrail assembly. This invention embodies a means to provide safety compliance while at the same time decreasing the handrail assembly weight by as much as 60%, thus providing to the user a desired and optimal payload rating for the elevator cab in view of the weight savings to which the invention informs.

### BACKGROUND OF THE INVENTION

Existing top of car handrail systems are either comprised of angle iron, hat sections, Unistrut® or welded tube and tend to be heavy in view of safety requirements relating to horizontal and vertical force resistance for top of car elevator safety applications in the elevator shaft. The present state of commercially available technologies typically requires materials weighing between 140 and 200 lbs. for a typical 8′×8′ envelope, thus reducing, by equal measure, the gross weight rating of the elevator car itself. In many examples of the current state of the art, the corner assemblies securing the handrails are often very heavy fabrications, due, in large part to the need to affix two heavy welded tubes, Unistrut®, hat sections or angle iron, resulting in excessive weight relative to the compliance requirements of ASME A17.1-2016 and CAD 277-19, when considering the present invention. Known systems utilize welded close-corner assemblies, castings or heavy gauge brackets which, when used with a set screw or other securing hardware, are merely applying axial force to a surface, both of which can be the subject of loosening in the field, inconsistent in application and thus may cause safety performance deterioration.

It would be advantageous to develop a weight saving, non-welded structural system and method which, when assembled as a structural system, complies with ASME A17.1-2016 and CAD 277-19, yet improves the optimal weight rating for the elevator cab through substantial reduction in weight of the top of car handrail assembly situated above the cab.

### SUMMARY OF THE INVENTION

The invention disclosed herein overcomes the problems described above. The telescopic handrails are formed with not less than six (6) bends for the outside section and not less than five (5) bends for the inside section, integrated and interlocking with a corner post assembly of not less than twelve (12) formed transverse and enveloping interior surfaces with interlocked handrail bracket assemblies comprising not less than eleven (11) bends and an end post bracket assembly of not less than eight (8) formed transverse and enveloping interior surfaces with interlocked handrail bracket assemblies comprising not less than eight (8) bends, both assemblies of which mimic the outside profiles of the inner and outer telescopic handrails, with transverse mounting to an elongate square structure comprising not less than seven (7) bends, all mechanically secured through the use of light duty mechanical fasteners, resulting in a mechanical structure of superior strength to weight ratio, thus obviating the need for thicker and heavier gauge welded tube which is difficult and more cumbersome to punch/cut and fabricate and transport, among other things. Use of thicker gauge Unistrut®, hat sections or angle iron, is also rendered unnecessarily costly and weighty. The current commercially available handrail systems thus applied crude and laborious assembly with otherwise overly heavy components in order to comply with safety requirements as embodied in the ASME and CAD specifications cited above. The present invention provides a structural system and method incorporating telescopic handrails comprised of not less than six bends for the outside section and not less than five bends for the inside section, integrated and interlocking with formed and interlocked handrail bracket assemblies comprising not less than eight bends at the open ends and not less than eleven bends in the corners, riveted, interlocked and screwed together, thus culminating in the structural system upon which greater horizontal and vertical forces can be resisted with less weighty materials used. This invention ameliorates conditions indicative of vibration loosened axial bolt assembly or the need for overly heavy gauge materials required, incorporating formed handrails integrated and interlocking with formed and interlocked handrail bracket assemblies and further interlocked with integrated post assemblies, comprising the structural system thus informed.

In a preferred embodiment, the present invention is directed to an elevator car, which, under current ASME/CAD safety considerations, requires a compliant top of car handrail assembly which shall keep the service or installation technician within the handrail confined safe area. Originally designed systems with welded tube, for example, typically require more than one field assembly technician for assembly due to excessive weight and the cumbersome and unsafe manner in which the telescopic inner tube may slide out of the outer tube, potentially causing an injury in assembly to those on the top of the car or those unsuspecting such danger below in the elevator shaft, among other things. The Lightweight Integrated Post and Handrail System comprises at least two (2) lightweight elongate square posts, each with not less than seven (7) bends, with integrated locking bracketry incorporating material to material interlocking, riveting and other locking technologies in which to simply connect to a “mounting shoe” thus comprising a multi-planar mechanical connection to the car, using material to material (clip tab and slot) connections with only one (1) accompanying fastener per shoe and post assembly, which integrated bracketry thus forms an enveloped encasement around the inner or outer telescopic rail ends described above, comprising the Multi-planar System and Method described herein. The mounting shoes connect to the car through various intermediate means, such as Unistrut to nut and bolt connectivity, which allows for a stable base upon which the Multi-planar System and Method defined herein can resist both horizontal and vertical loads. In a preferred embodiment, the mounting shoes may be connected to the car using heavy duty fasteners, in which the integrated elongate square post is thus inserted and fastened, connected to the handrails described above, through the integrated posts, the configuration of which comprises this Multi-planar System and Method informed herein. However, such a configuration is not meant to limit the shape or overall dimensions of the present embodiment. The configuration examples could be implemented with as few as two sides and as many or more than ten sides or decagonal structure. Additionally, the configuration examples could be constructed from any lightweight bendable material, including mild steel or aluminum, with or without corrosion coating.

The Multi-planar Lightweight Integrated Post and Handrail System is designed and configured to aid in the ease of assembly requiring only one technician with limited tools in order to assemble the System in as little as ten minutes.

The Multi-planar Integrated Elongate Square Post, when inserted into the mounting shoe, provides lightweight, yet considerable resistance to both horizontal and vertical loads when connected to the telescopic handrail brackets, which mimic the form of the profile of the handrail with minimal clearance and fastening, enabling the integration of the Integrated Elongate Square Post to the Telescopic Handrail to perform as a strong and robust Multi-planar System.

The Multi-planar Integrated Post and Handrail System is also designed and configured to inhibit the sliding of internal rails as is common in welded tubular handrail designs of different inside and outside dimensions, thus obviating dangerous accidents caused by falling or sliding heavy tube components, both at the top of car and below in the elevator shaft.

The Multi-planar Integrated Post and Handrail System embodies a favorable means of providing equivalent or superior horizontal and vertical force resistance while reducing weight of the structure, material and installation costs.

The Multi-planar Integrated Post and Handrail System incorporates an assembly time-saving extendable kick plate, designed to withstand substantial horizontal forces with the use of only one fastener, as the kick plate incorporates the same clip tab and slot mechanical joining technology in which to affix the plate to the System.

### BRIEF DESCRIPTION OF THE DRAWINGS

FIG. 1 shows an isometric view of the Multi-planar Integrated Post and Handrail System according to an embodiment of the present invention.

FIG. 2 shows an exploded isometric view of the unassembled components of the system of FIG. 1.

FIG. 3 shows an exploded isometric view of a corner portion of the system of FIG. 1.

FIG. 3A shows an exploded view of an unassembled integrated post mounting to the shoe portion of the system of FIG. 3.

FIG. 4 shows an enlarged isometric view of the mechanical joining of the handrail to the integrated end post bracketry of the system of FIG. 1.

FIG. 4A shows an exploded isometric view of the unassembled components of the system of FIG. 4.

FIG. 4B shows an exploded cross-section of the post of FIGS. 4 and 4A.

FIG. 5 shows an inward facing view of the mechanical joining of the handrail to the integrated end post bracketry of the system of FIG. 1.

FIG. 6 shows side view, partially in cross section, of the mechanical joining of the handrail to the integrated end post bracketry of the system of FIG. 1.

FIG. 7 shows an outward facing view of the mechanical joining of the to the integrated end post bracketry of the system of FIG. 1.

FIG. 8 shows a second side view, partially in cross section, of the mechanical joining of the handrail 117 to the integrated end post and bracketry of the system of FIG. 1.

FIG. 9 shows an isometric view of the integrated corner bracketry of the system of FIG. 1.

FIG. 9A shows an exploded isometric view of the unassembled components of the system of FIG. 9.

FIG. 9B shows an exploded cross-section of the post of FIGS. 9 and 9A.

FIG. 10 shows a side view, partially in cross section, of the integrated corner bracketry of the system of FIG. 9.

FIG. 11 shows a second side view and cross section of the integrated corner bracketry of the system of FIG. 9.

FIG. 12 shows an outward facing view and opposing cross section of the integrated corner bracketry of the system of FIG. 9.

FIG. 13 shows an outward facing second view and opposing cross section of the integrated corner bracketry of the system of FIG. 9.

FIG. 14 shows the end section view as seen from the vantage point of the inner facing telescopic handrail and a cross-section view as seen from the vantage point of the outer facing telescopic handrail according to an embodiment of the present invention.

FIG. 15 shows the end section view as seen from the vantage point of the outer facing telescopic handrail and a cross-section view as seen from the vantage point of the inner facing telescopic handrail according to an embodiment of the present invention.

FIG. 16 shows the unassembled end post support bracket of the system of FIG. 1.

### DETAILED DESCRIPTION OF THE INVENTION

Embodiments of the present invention disclosed relate to a top of elevator handrail assembly that includes rails, posts and shoe mounting to the top of an elevator car, all of which represent a novel means of design and construction not heretofore used in various fields of deployment of handrail systems. For instance, tubular telescopic rails, which have been used extensively in the past and which generally require a set screw type securing to the second smaller or larger tube from which extension is thus made possible, is now rendered overly weighty and thus costly in terms of components, shipment and final assembly.

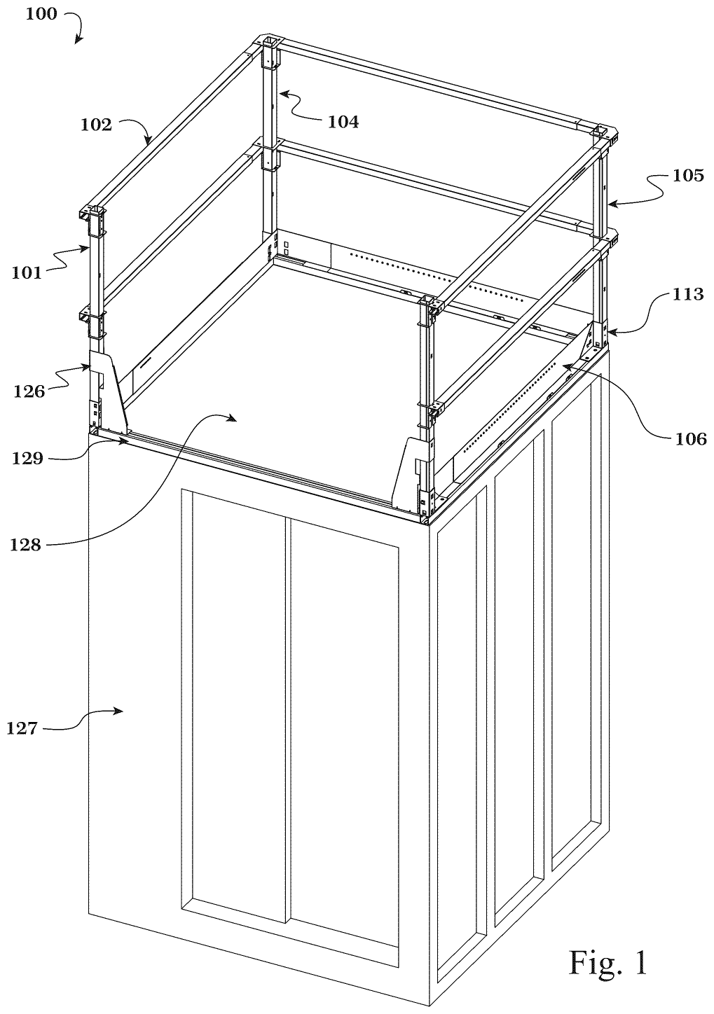

FIG. 1 shows an isometric view of the System 100 comprised of the integrated end post 101, integrated corner posts 104, 105, shoe 113, kickplate 106, end post support bracket 126, elevator car 127, elevator car roof 128, Unistrut® or other mounting rail 129 and handrail System components 100 according to an embodiment of the present invention.

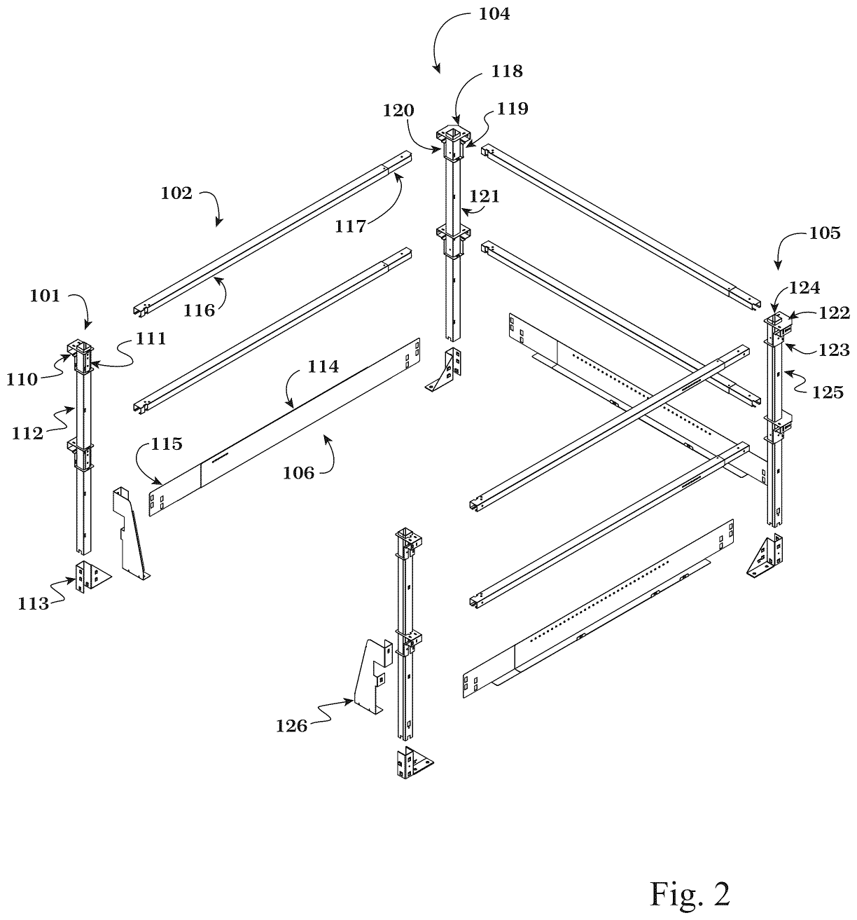

FIG. 2 shows an isometric view of the Structural System of unassembled components comprising the integrated end post 101, integrated corner posts 104 and 105, shoe 113, kickplate 106, end post bracket and retainer clip 110, 111, integrated end post 101, adjustable kick plate 106 comprised of 114 and 115 plates, 102 telescopic handrail comprised of 116 outer and 117 inner handrail components, integrated corner post 104 comprised of square post assembly 121 and bracket assemblies 118, 119 and 120 which accepts one inner rail 117 and one outer rail 116, integrated corner post 105 comprised of square post assembly 125 and bracket assemblies 122, 123 and 124, and end post support bracket 126 with integrated post 105, showing the bracket assemblies of 122, 123 and 124 required to accommodate similar profiles of handrails, such as 117 shown, according to an embodiment of the present invention.

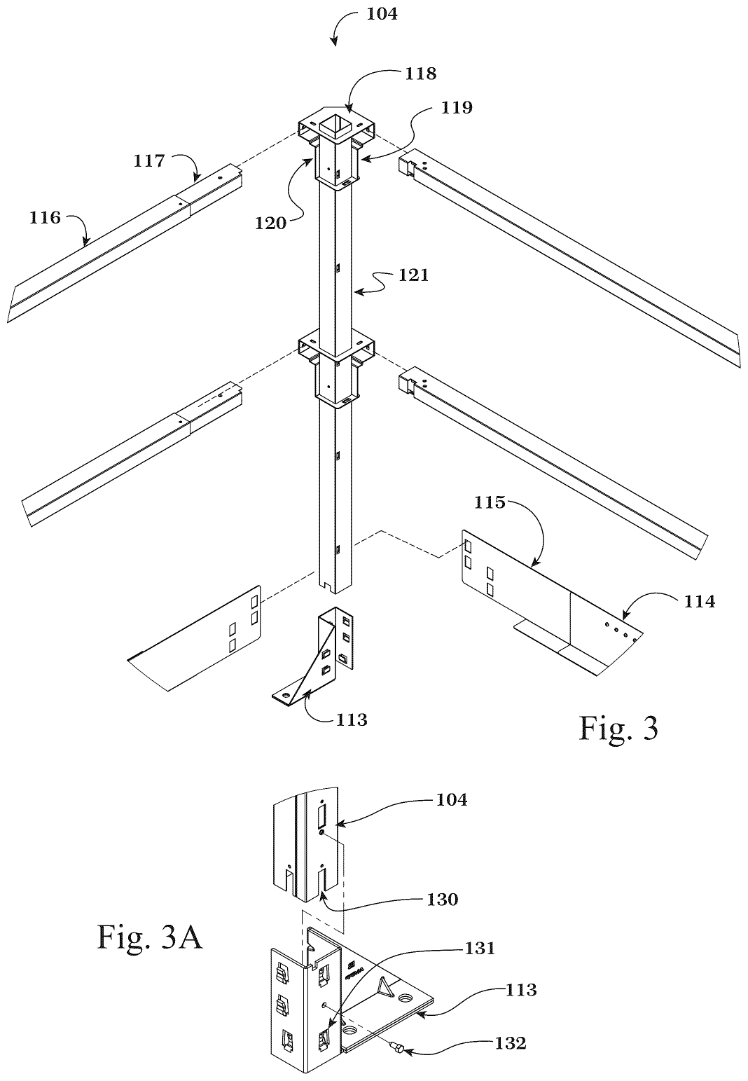

FIG. 3 shows an isometric view of the detailed and separate telescopic handrail comprised of 116 and 117, kickplate components 114 and 115, which mechanically connect to the integrated corner post 104, shoe 113 and bracketry 118, 119, 120 and 121 which mimics the profile of the telescopic handrail according to an embodiment of the present invention.

FIG. 3A shows an isometric view of the detailed mechanical joining of the integrated corner post 104 inserted into the shoe 113, utilizing slots 130 which mate with clip tabs 131 and positively positioned with the self-tapping screw 132 according to an embodiment of the present invention.

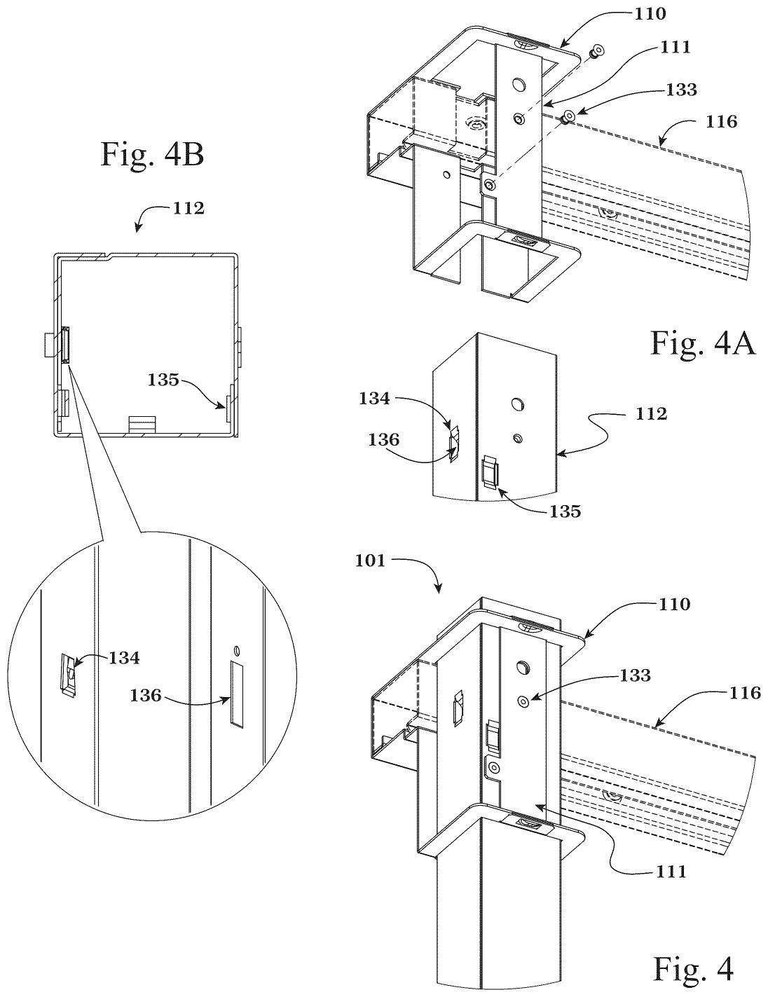

FIG. 4 shows an isometric view of the detailed mechanical joining of the telescopic handrail 116 which mechanically connects to the integrated end post 101 consisting of bracketry 110, 111, 112 mimicking and encapsulating the profile of the telescopic handrail 116 according to an embodiment of the present invention.

FIG. 4A shows an isometric view of the detailed mechanical joining of the post 112 comprised of two elongate components mated together with the clip tabs 134 into slots 136 with lance and form 135 into slots 136 comprising the elongate post of 112 prior to assembly with brackets 110 and 111 as mechanically joined to culminate in an integrated end post 101 according to an embodiment of the present invention.

FIG. 4B shows a cross-section view of post 112 with clip tabs 134 into slots 136 and the view of lance and form 135 as the lance protrudes into slots 136, as detailed isometrically in FIG. 4A, according to an embodiment of the present invention.

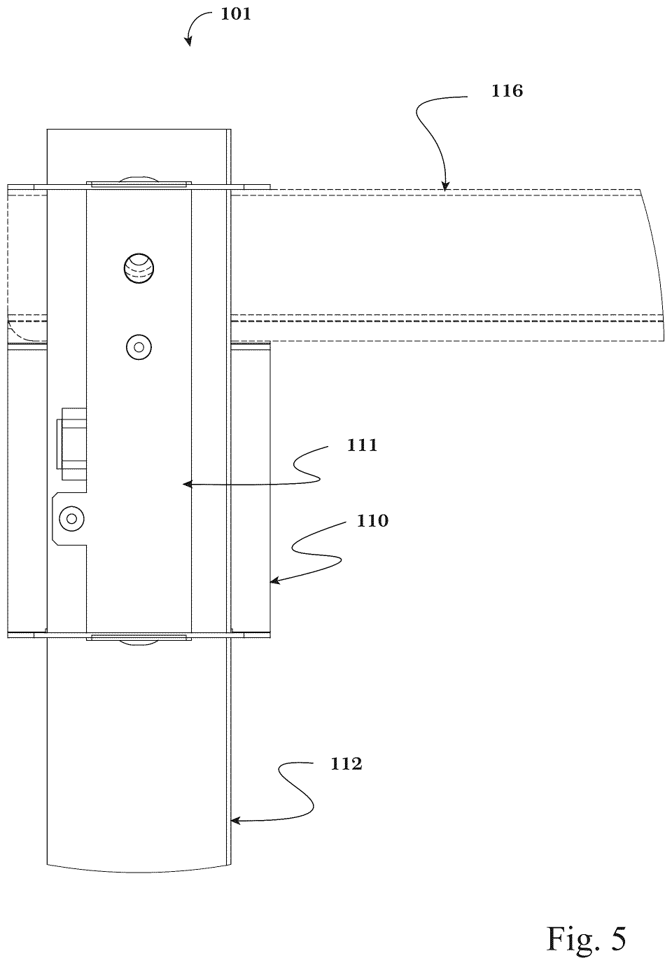

FIG. 5 shows an inward facing view of the detailed mechanical joining of the telescopic handrail 116 which mechanically connects to the integrated end post bracketry 110, 111 mimicking and encapsulating the profile of the telescopic handrail according to an embodiment of the present invention.

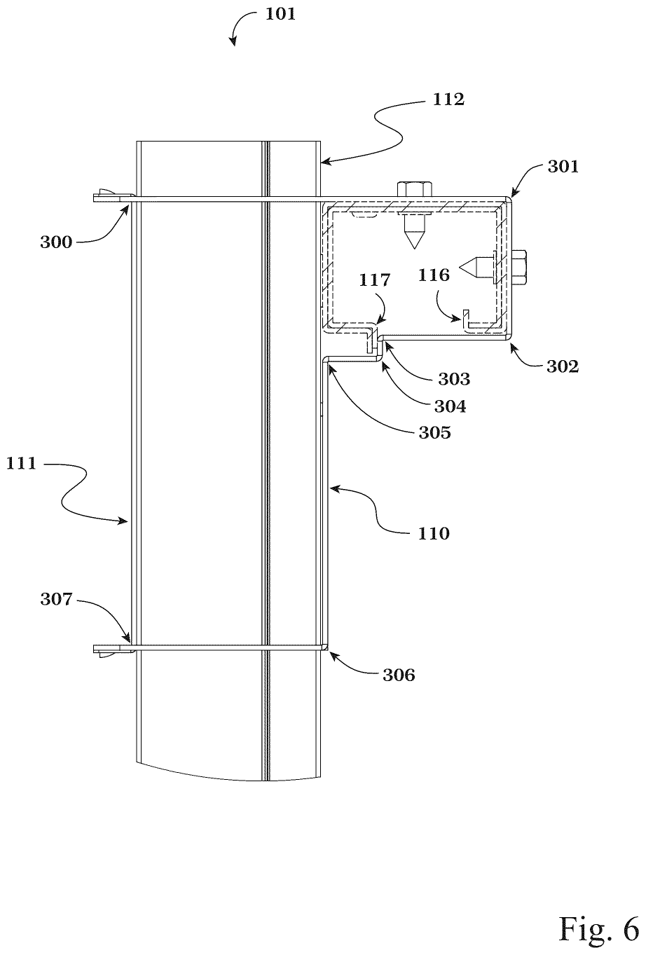

FIG. 6 shows side view and cross section of the detailed mechanical joining of the telescopic handrail 116, 117 which mechanically connects to the enveloping and integrated end post bracketry 110, 111 and 112 mimicking and encapsulating the profile of the telescopic handrail 116 as positioned and fastened with self-tapping screw 132, the transverse mounted bracketry of which is provided with a first bend 300, a second bend 301, third bend 302, fourth bend 303, fifth bend 304, sixth bend 305, seventh bend 306 and eighth bend 307 according to an embodiment of the present invention.

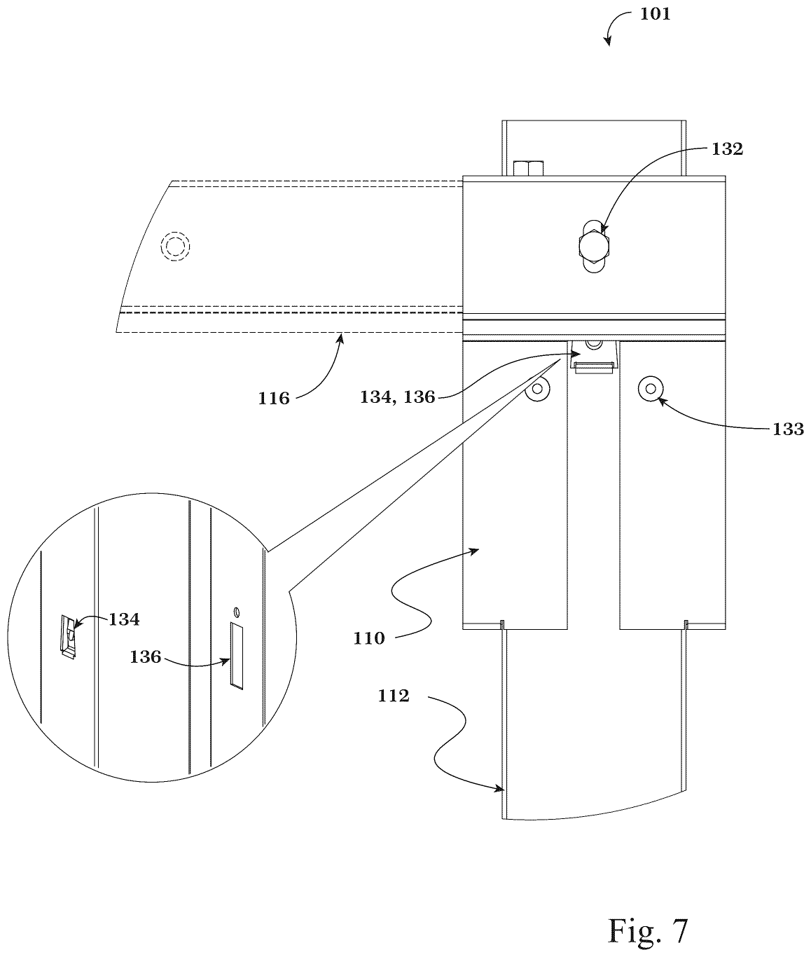

FIG. 7 shows an outward facing view of the detailed mechanical joining of the telescopic handrail 116 which mechanically connects to the integrated end post 101 bracketry 110 and 112, which further shows an exploded view of clip tab 134 into slot 136 required for assembly of post 112, mimicking and encapsulating the profile of the telescopic handrail 116 as positioned and fastened with self-tapping screw 132 and rivets 133 according to an embodiment of the present invention.

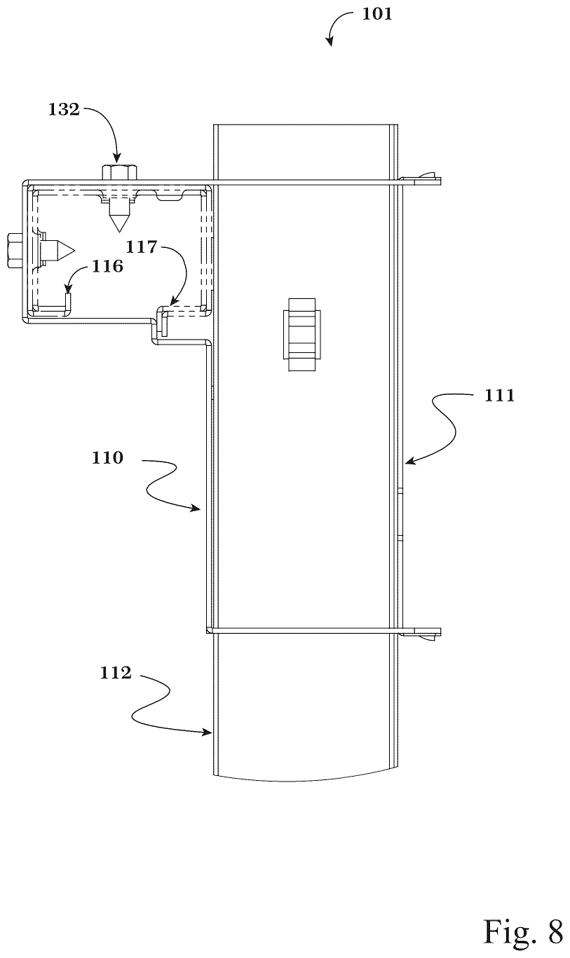

FIG. 8 shows a second side view and cross section of the detailed mechanical joining of the telescopic handrail 116 which mechanically connects to the integrated end post 101 bracketry 110, 111, 112 mimicking and encapsulating the profile of the telescopic handrail 116 as positioned and fastened with self-tapping screws 132 according to an embodiment of the present invention.

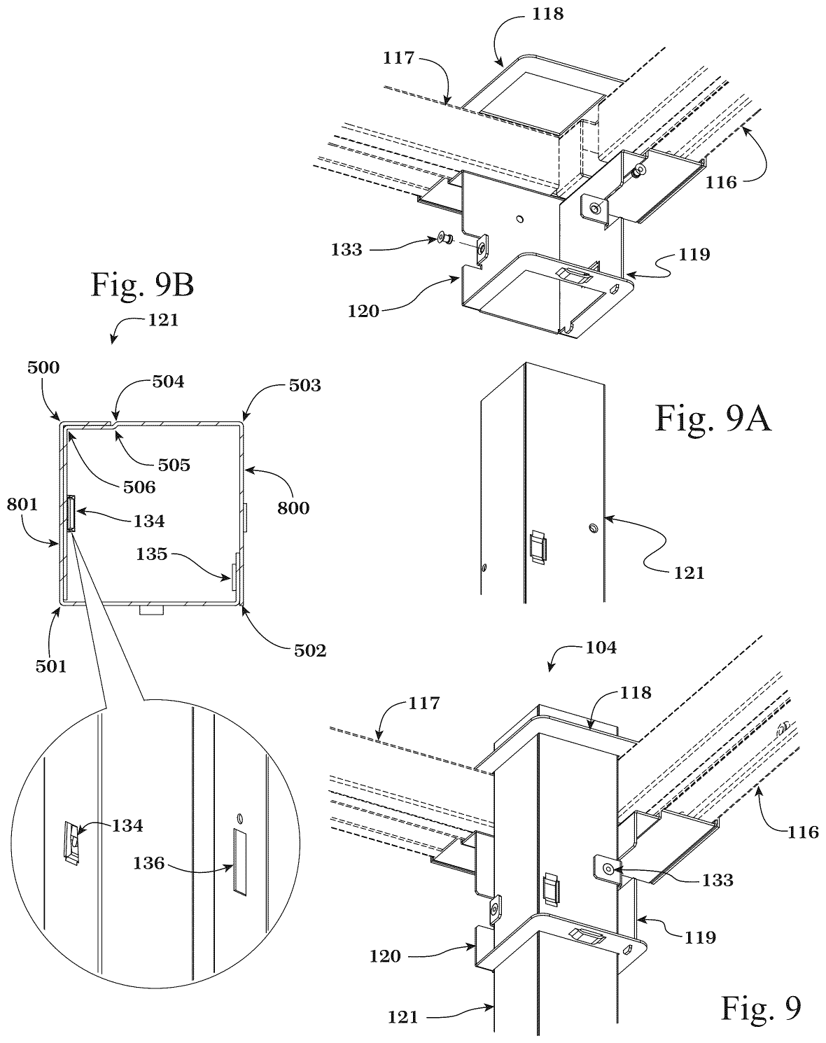

FIG. 9 shows an isometric view of the integrated corner post 104 bracketry 118, 119, 120 and 121 mimicking and encapsulating the profile of the telescopic handrails 117 and 116 according to an embodiment of the present invention.

FIG. 9A shows an isometric view of the detailed mechanical joining of the post 121 comprised of two elongate components mated together with the clip tabs 134 into slots 136 with lance and form 135 into slots 136 comprising the elongate post of 121 prior to assembly with brackets 118, 119, 120 and 121 as mechanically joined to culminate in an integrated corner post 104 according to an embodiment of the present invention.

FIG. 9B shows a cross-section view of post 121 with clip tabs 134 into slots 136 and the view of lance and form 135 as the lance protrudes into slots 136, the elongate post 121 is formed of first and second components 800 and 801 that together define a square cross section, with not less than seven bends along the length of the elongate post, as best illustrated with a first bend 500, a second bend 501, third bend 502, fourth bend 503, fifth bend 504, sixth bend 505, and a seventh bend 506 according to an embodiment of the present invention.

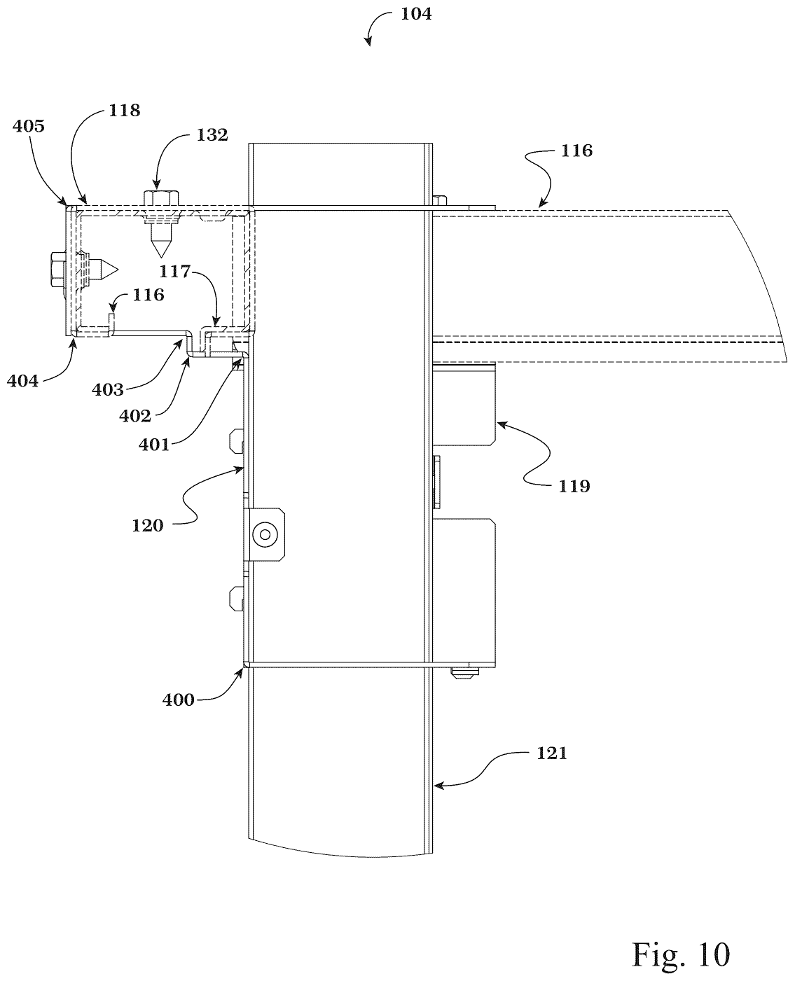

FIG. 10 shows a first side view and cross section of the integrated corner 104 bracketry 118, 119, 120 and 121 mimicking and encapsulating the profile of the telescopic handrails 116, 117 as mechanically joined by self-tapping screws 132, the transverse mounted bracketry of which is provided with a first bend 400, a second bend 401, third bend 402, fourth bend 403, fifth bend 404, sixth bend 405 according to an embodiment of the present invention.

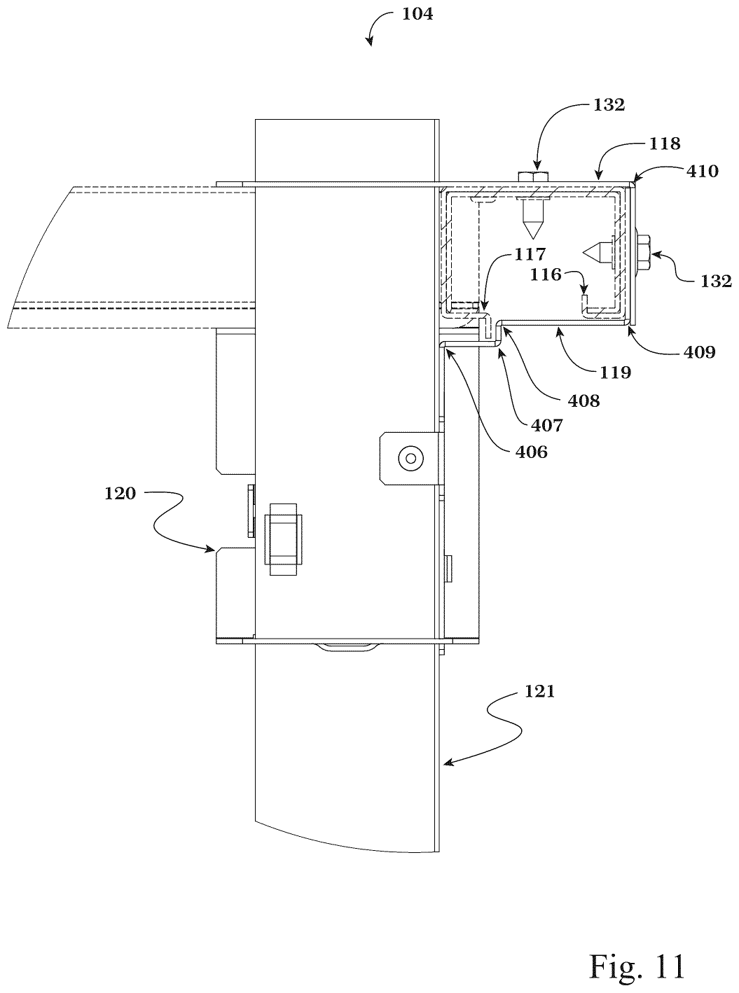

FIG. 11 shows a second side view and cross section of the integrated corner 104 bracketry 118, 119, 120 and 121 mimicking and encapsulating the profile of the telescopic handrails 116, 117 as mechanically joined by self-tapping screws 132 the transverse mounted bracketry of which is provided with a seventh bend 406, eighth bend 407, ninth bend 408, tenth bend 409 and eleventh bend 410 according to an embodiment of the present invention.

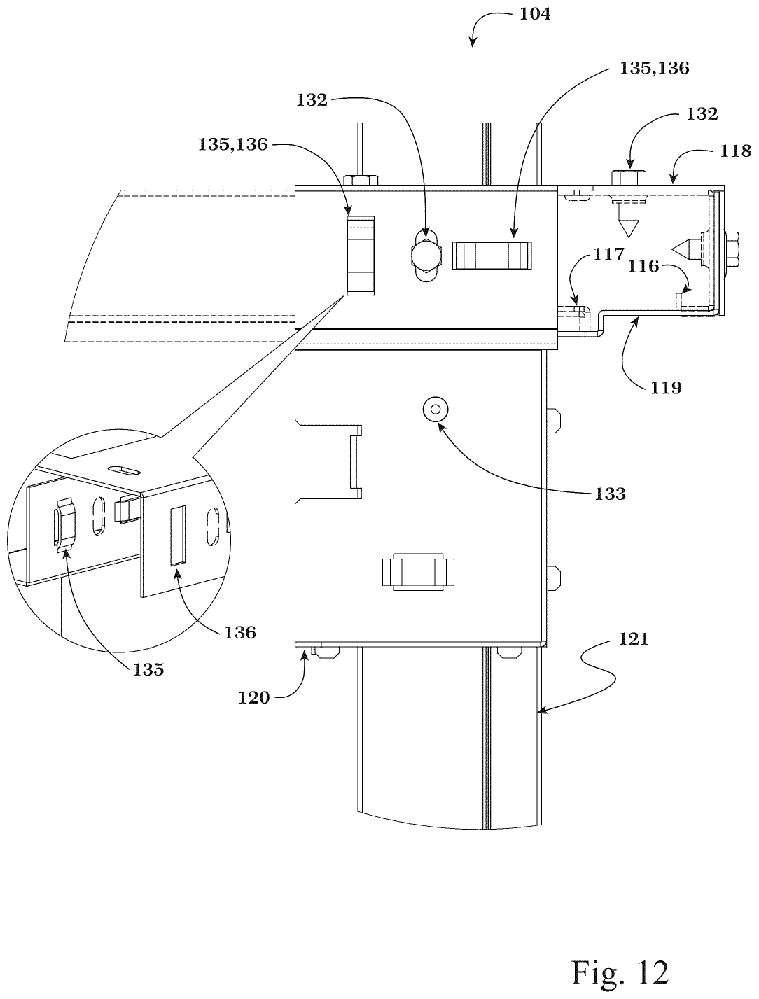

FIG. 12 shows an outward facing view and opposing cross section of the integrated corner 104 bracketry 118, 119, 120 and 121, with lance and form 135 protruding outward from brackets 119, 120 into transverse slots 136 in bracket 118 required to lock the assembly thereof in latitudinal and longitudinal directions, when screw 132 is installed, mimicking and encapsulating the profile of the telescopic handrails 116, 117 further mechanically joined by self-tapping screws 132 and rivet 133 according to an embodiment of the present invention.

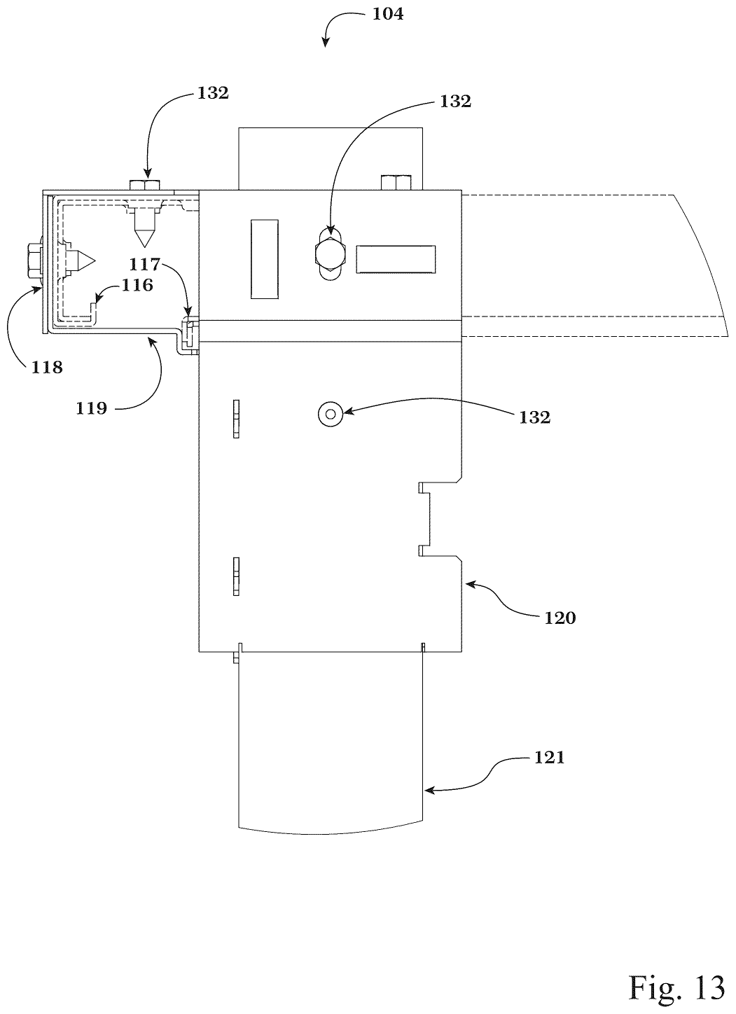

FIG. 13 shows an outward facing second view and opposing cross section of the integrated corner 104 bracketry 118, 119, 120 and 121, with lance and form 135 protruding outward from brackets 119, 120 into transverse slots 136 in bracket 118 required to lock the assembly thereof in latitudinal and longitudinal directions, when screw 132 is installed, mimicking and encapsulating the profile of the telescopic handrails 116, 117 mechanically joined by self-tapping screws 132 and rivet 133 according to an embodiment of the present invention.

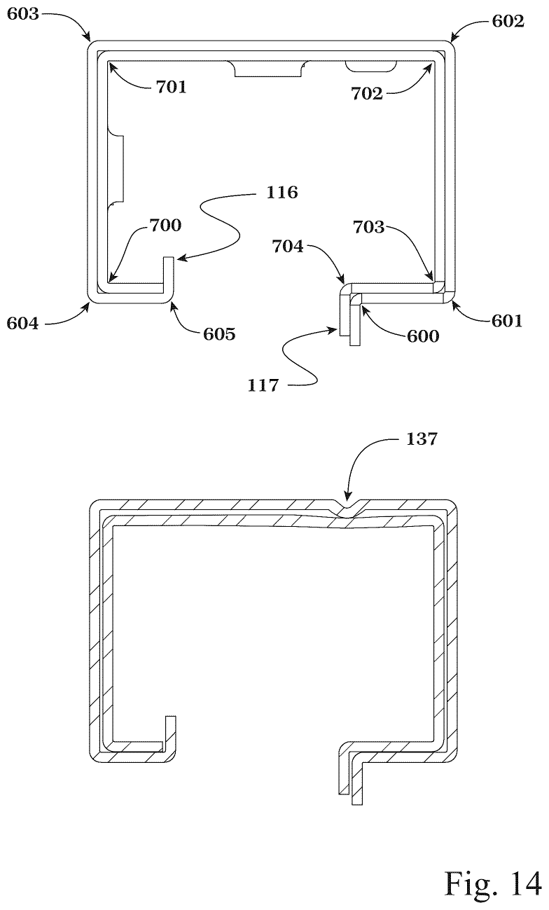

FIG. 14 shows the end view and cross-section view as seen from the vantage point of the inner facing telescopic handrail 117 as inserted into 116, which includes not less than six (6) bends along its length and is provided with a first bend 600, a second bend 601, third bend 602, fourth bend 603, fifth bend 604, and a sixth bend 605, with dimple protrusion 137 onto handrail 117, which includes not less than five (5) bends along its length and is provided with a first bend 700, a second bend 701, third bend 702, fourth bend 703 and a fifth bend 704 according to an embodiment of the present invention.

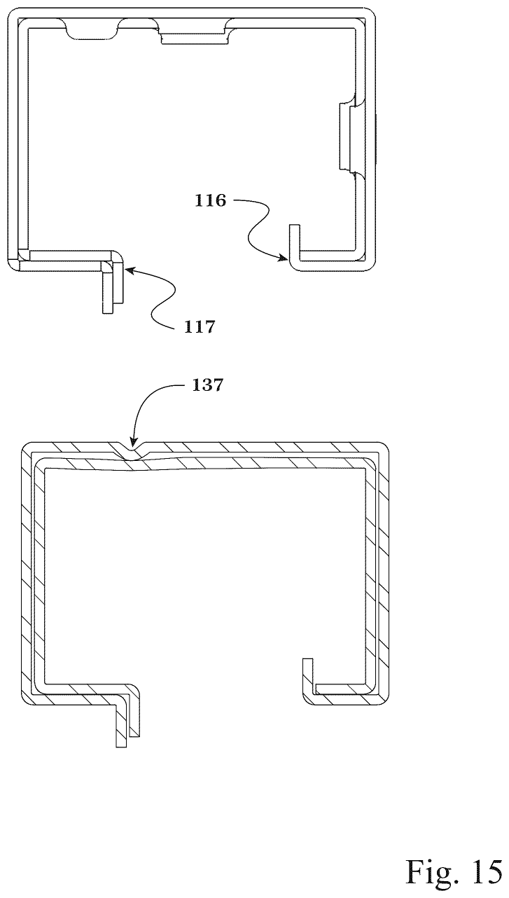

FIG. 15 shows the end view and cross-section view as seen from the vantage point of the outer facing telescopic handrail 116 as received by 117 with dimple protrusion 137 onto handrail 117 according to an embodiment of the present invention.

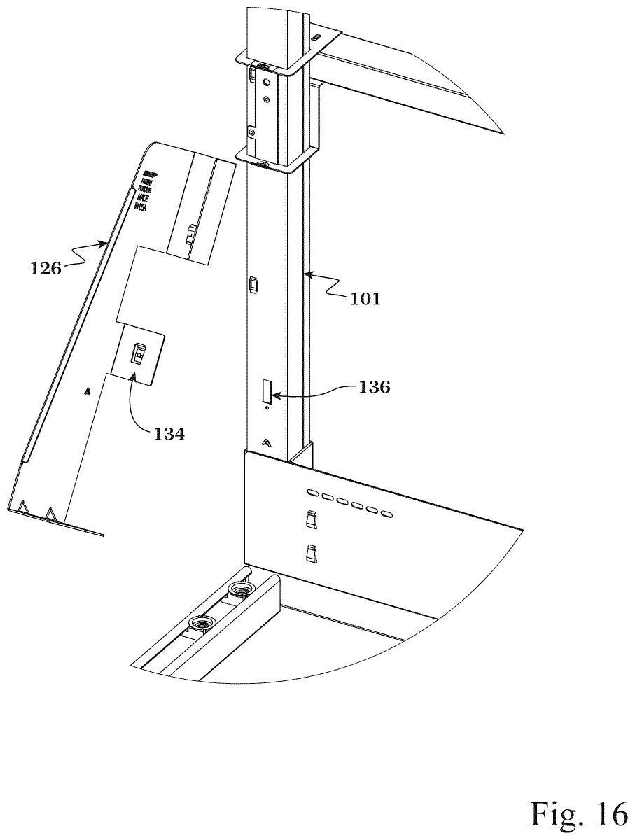

FIG. 16 shows the end support bracket 126 as viewed from the inside of the system assembly with clip tab 134 to mate with slot 136 on post 101 according to an embodiment of the present invention.

In accordance with the provisions of the patent statutes, the invention has been described in what is considered to represent its preferred embodiments. However, it should be noted that the invention can be practiced otherwise than as specifically illustrated and described without departing from its spirit or scope.

1. An integrated telescopic rail and modular post assembly, comprising:
a first elongate post comprising an assembly of a first and second component that together define a square in cross section, with not less than seven (7) bends along the length of the elongate post;
a handrail having a first end affixed to the first elongate post, the handrail including an elongate, inner handrail member of not less than five (5) bends along its length, received within an elongate, outer handrail member of not less than six (6) bends along its length; and
a mechanical bracket mimicking and enveloping the surface profiles of the elongate posts and handrails comprised of apertures which envelope about the profiles of the elongate rail and post members, the integration of which resists outward or inward applied longitudinal or lateral forces.

2. The integrated telescopic rail and modular post assembly of claim 1, comprising a mounting shoe system, wherein the first and second elongate square posts terminate in a shoe which mimics the profile of the modular integrated square post assembly, thus affixed to the shoe by mechanical clinching of lance and formed clips incorporated thereon the shoe which mate to precise slots in the elongate square posts on not less than three (3) sides of the post and four (4) mechanical clinching points. A mechanical faster in the form of a self-tapping screw or other means assures that the coplanar post is positioned correctly to the terminal mounting shoe.

3. The integrated telescopic rail and modular post assembly of claim 1, comprising an end post connector system, wherein the first elongate square post incorporates a connector system having:
a formed bracket of not less than six (6) surfaces culminating in an aperture, which envelope about the profile of a connecting outer, and thus larger profile, telescopic rail member;
said formed bracket of not less than eight (8) bends incorporates a plurality of transversely positioned square apertures with notches to receive a retention bracket in which to mimic the profile of the first elongate post and thus envelope the coplanar square surfaces thus mechanically culminated;
said retention bracket which interlocks by mechanical fastener into the first formed bracket, which, when affixed to the first elongate post, structurally causes the connector system to resist tension and shear forces as applied to the first elongate post and integrated telescopic rail.

4. The integrated telescopic rail and modular post assembly of claim 1, comprising a corner post connector system, wherein a second elongate post, incorporates a connector system comprising:
a formed bracket of not less than six (6) surfaces culminating in an aperture which envelope about the profile of a connecting outer, and thus larger profile, telescopic rail member, mechanically integrated with another formed bracket of not less than six (6) surfaces, mechanically integrated with another formed bracket of not less than three (3) surfaces thus mechanically culminating in an aperture envelope about the profile of a connecting inner, and thus smaller profile, telescopic rail member of not less than eleven (11) total bends;
said formed brackets incorporate and integrate a plurality of transversely positioned square holes, further incorporating a retention bracket surface which, when affixed and located to the second elongate post by mechanical fastener, structurally causes the connector system to resist tension and shear forces as applied to the second elongate post and integrated telescopic rail connection system and method.

5. The corner post connector system assembly of claim 4, comprising a corner system, wherein the distal ends of each telescopic rail are received as (1) inner and (1) outer telescopic rail per integrated connector, configured to mimic each such profile of the different interstices to ensure correct assembly in the field, the number of corner assemblies of which shall depend upon the number of horizontal rails required. The corner assembly of claim 4 shall be comprised of not less than eleven (11) bends in total.

6. The integrated telescopic rail and modular post assembly of claim 1, comprising telescopic handrails, each incorporating a formed friction dimple, which inhibits the rails from separating until extended in the system assembly.

7. The integrated telescopic rail and modular post assembly of claim 1, comprising a construction system, wherein mechanical fasteners such as self-tapping screws are used to secure each component into position, thus further providing and assuring adequate shear and tension resistance in all axes, when deployed in conjunction with the tab clip and slot interconnection of the mounting shoe system of claim 2.

8. The integrated telescopic rail and modular post assembly of claim 1, comprising mechanical fasteners according to all claims herein are required first to confirm proper location and seating of the mechanical joining means of the multiplanar surfaces, and secondarily and correspondingly provide mechanical joining to ensure proper mechanical clinching of the multiplanar surfaces so mechanically connected through the clip tab and slots and lance and form and slots thereon.

9. The mounting shoe system according to claim 2, which may be affixed to any flat, Unistrut®, threaded rail or through-hole bolted surfaces.

10. The integrated telescopic rail and modular post assembly of claim 1, comprising the end post support bracket, which inhibits outward forces as may be applied to an open-ended enclosure.

11. The integrated telescopic rail and modular post assembly of claim 1, comprising the elongate posts, each of which has a different slot configuration in order to ensure proper system assembly to each mounting shoe.

12. The integrated telescopic rail and modular post assembly of claim 1, comprising the mounting shoes, each of which has a different clip tab configuration in order to ensure proper system assembly to each integrated post.
